(19) United States
(12) Patent Application Publication
(10) Pub. No.: US 2018/0059882 A1
(43) Pub. Date: Mar. 1, 2018

(54) INFORMATION PROCESSING APPARATUS THAT PERFORMS IMAGE LAYOUT, METHOD OF CONTROLLING THE SAME, AND STORAGE MEDIUM

(71) Applicant: CANON KABUSHIKI KAISHA, Tokyo (JP)

(72) Inventor: Koichi Tanabe, Kawasaki-shi (JP)

(21) Appl. No.: 15/681,499

(22) Filed: Aug. 21, 2017

(30) Foreign Application Priority Data
Aug. 29, 2016 (JP) 2016-166849

(51) Int. Cl. G06F 3/0482; G06F 3/0484; G06F 17/30

(52) U.S. Cl. CPC G06F 3/0482; G06F 17/30274; G06F 3/0484

(57) ABSTRACT

An information processing apparatus that starts editing of a photobook without waiting for completion of uploading all image data items, and prevents results of editing already performed from being affected by image data items uploaded later. A book editing apparatus performs a layout process for laying out layout objects on pages. The book editing apparatus receives the layout objects. A CPU additionally displays each layout object in an upload image area whenever the layout object is received. The CPU decides page layout patterns for laying out the layout objects on the pages based on attribute information of the layout objects. Whenever each page layout pattern is decided, the CPU lays out associated layout objects on associated pages according to the decided layout pattern, and additionally displays them in a layout area different from the upload image area.

### BACKGROUND OF THE INVENTION

### Field of the Invention

The present invention relates to an information processing apparatus that performs image layout, a method of controlling the same, and a storage medium, and more particularly to image layout of spread left and right pages, which is performed when a book, such as an electronic book, is generated.

### Description of the Related Art

In recent years, an internet service that creates a so-called photobook by using image data has come to be provided. This internet service includes one which automatically lays out image data items for a photobook on pages of the photobook, respectively (see Japanese Patent Laid-Open Publication No. 2014-106595).

Incidentally, in the above-described internet service, in a case where editing of the photobook is started after completion of uploading all image data items, a time period over which the user is compelled to wait becomes longer. On the other hand, when editing of the photobook is started without waiting for completion of uploading all image data items, details of editing are sometimes affected by image data items uploaded later. This results in creation of a photobook unintended by the user, which sometimes requires another photobook to be newly created again.

### SUMMARY OF THE INVENTION

The present invention provides an information processing apparatus that starts editing of a photobook without waiting for completion of uploading all image data items, and prevents results of editing already performed from being affected by image data items uploaded later, a method of controlling the same, and a storage medium.

In a first aspect of the invention, there is provided an information processing apparatus that performs a layout process for laying out layout objects to be laid out on pages, comprising a reception unit configured to receive each layout object, a display unit configured to additionally display the layout object in a first area, whenever the layout object is received, a decision unit configured to decide, based on attribute information of a plurality of the layout objects to be laid out on pages, a layout pattern for laying out the plurality of the layout objects on the pages, and a control unit configured to perform control such that whenever each layout pattern for associated ones of the pages is decided, associated ones of the layout objects are laid out on the associated pages, according to the decided layout pattern, and are additionally displayed in a second area different from the first area by the display unit.

In a second aspect of the invention, there is provided a method of performing a layout process for laying out layout objects on pages, comprising receiving each layout object, additionally displaying the layout object in a first area, whenever the layout object is received, deciding, based on attribute information of a plurality of the layout objects to be laid out on pages, a layout pattern for laying out the plurality of the layout objects on the pages, and laying out, whenever each layout pattern for associated ones of the pages is decided, associated ones of the layout objects on the associated pages, according to the decided layout pattern, and additionally displaying the associated ones of the layout objects in a second area different from the first area.

In a third aspect of the invention, there is provided a non-transitory computer-readable storage medium storing a computer-executable program for executing a method of performing a layout process for laying out layout objects on pages, wherein the method comprises receiving each layout object, additionally displaying the layout object in a first area, whenever the layout object is received, deciding, based on attribute information of a plurality of the layout objects to be laid out on pages, a layout pattern for laying out the plurality of the layout objects on the pages, and laying out, whenever each layout pattern for associated ones of the pages is decided, associated ones of the layout objects on the associated pages, according to the decided layout pattern, and additionally displaying the associated ones of the layout objects in a second area different from the first area.

According to the present invention, it is possible to start editing of a photobook without waiting for completion of receiving all layout objects, and prevents results of editing already performed from being affected by layout objects which are uploaded later.

Further features of the present invention will become apparent from the following description of exemplary embodiments (with reference to the attached drawings).

### BRIEF DESCRIPTION OF THE DRAWINGS

FIG. 1 is a diagram showing a network system including an information processing apparatus according to a first embodiment of the present invention.

FIG. 2 is a block diagram showing a hardware configuration of a book editing apparatus as the information processing apparatus according to the first embodiment, appearing in FIG. 1.

FIG. 3 is a diagram showing an example of a file selection screen displayed on a user terminal appearing in FIG. 1.

FIG. 4A is a flowchart of a layout process performed by the book editing apparatus.

FIG. 4B is a continuation of FIG. 4A.

FIG. 5 is a diagram showing an example of a book editing screen displayed on the book editing apparatus.

FIG. 6 is a diagram showing an example of a page layout group set in the book editing apparatus.

FIG. 7 is a diagram showing an example of a layout determination table defining rules with reference to which layout types are determined by the book editing apparatus.

FIG. 8 is a diagram showing an example of a book editing screen displayed on a book editing apparatus as an information processing apparatus according to a second embodiment of the present invention.

FIG. 9A is a flowchart of a layout process performed by the book editing apparatus.

FIG. 9B is a continuation of FIG. 9A.

### DESCRIPTION OF THE EMBODIMENTS

The present invention will now be described in detail below with reference to the accompanying drawings showing embodiments thereof.

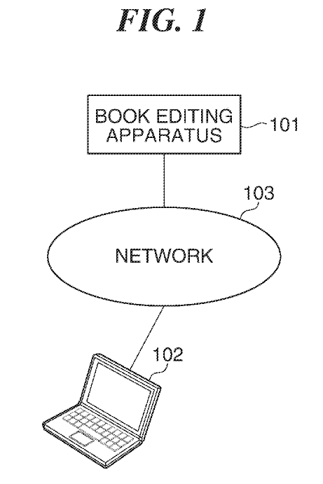

FIG. 1 is a diagram showing an example of a network system including an information processing apparatus according to a first embodiment of the present invention.

Referring to FIG. 1, a book editing apparatus 101 as one information processing apparatus (the information processing apparatus according to the first embodiment) is connected to a user terminal device (hereinafter simply referred to as the “user terminal”) 102 as the other information processing apparatus via a network (e.g. the Internet) 103. The illustrated user terminal 102 is e.g. a general-purpose apparatus, such as a PC or a smartphone, and performs book editing by accessing the book editing apparatus 101 by a communication protocol, such as HTTP, using a browser via the network 103.

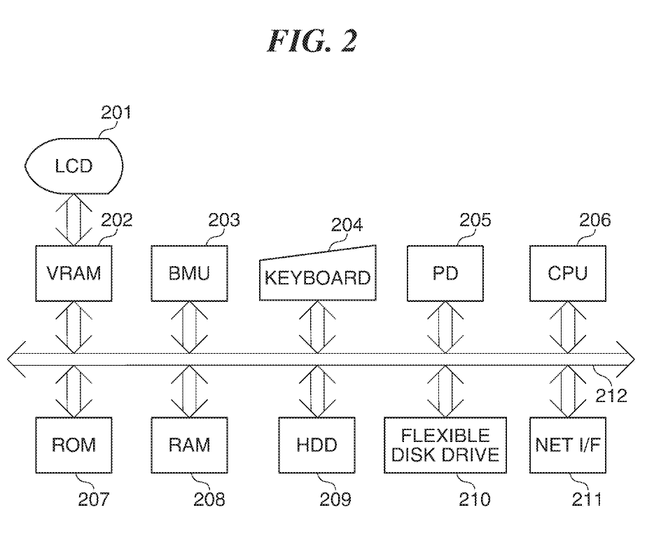

FIG. 2 is a block diagram showing a hardware configuration of the book editing apparatus 101 appearing in FIG. 1. Note that the hardware configuration of the user terminal 102 appearing in FIG. 1 is the same as the hardware configuration illustrated in FIG. 2.

As shown in FIG. 2, the book editing apparatus 101 is comprised of a display (e.g. LCD) 201, a VRAM (video RAM) 202, a BMU (bit move unit) 203, a keyboard 204, a PD (pointing device) 205, a CPU 206, a ROM 207, a RAM 208, an HDD 209, a flexible disk drive 210, and a network interface (NET I/F) 211. These blocks are connected to each other by a bus 212.

The display (display device) 201 displays a user interface e.g. for use in inputting passwords, and various kinds of information. The VRAM 202 stores various data items for being displayed on the display 201. The data items stored in the VRAM 202 are transferred to the display 201 according to a predetermined procedure, and screens are displayed on the display 201 based on data items.

The BMU 203 controls data transfer e.g. between memories (e.g. between the VRAM 202 and another memory, not shown), and data transfer between a memory and each I/O device (e.g. the network interface 211). The keyboard 204 includes various keys for inputting characters and the like.

The PD 205 is used e.g. for indicating objects, such as icons, menus, or other contents, which are displayed on the display 201, and dragging and dropping displayed objects. The CPU 206 controls the overall operation of the book editing apparatus 101 based on an OS (operating system) and control programs stored in the ROM 207, the HDD 209, and/or the flexible disk drive 210.

The ROM 207 stores some of the control programs and data. The RAM 208 is used as a work area for the CPU 206, an area for saving data in error handling, an area for loading the control programs, and so forth. The HDD 209 stores a book editing application program, described hereinafter, some of the control programs, and image files which have been uploaded from the user terminal 102.

The network interface 211 communicates with the other information processing apparatus (e.g. the user terminal 102), a printer (not shown), and the like, via the network 103. The bus 212 includes an address bus, a data bus, and a control bus.

Note that although the control programs operated by the CPU 206 are read from the ROM 207, the HDD 209, and/or the flexible disk drive 210, the control programs may be downloaded e.g. from an external apparatus through the network 103 via the network interface 211.

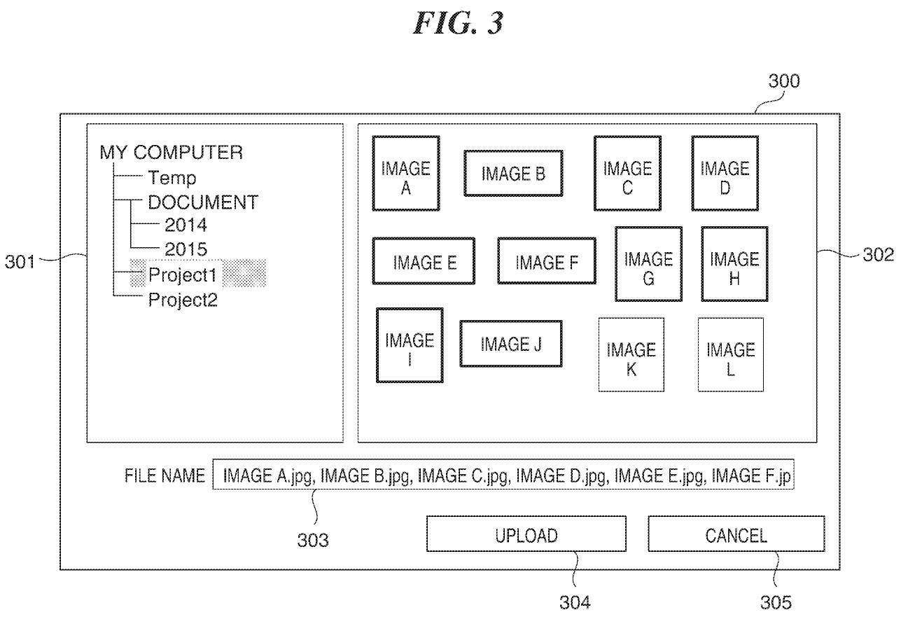

FIG. 3 is a diagram showing an example of a file selection screen 300 displayed on the user terminal 102 appearing in FIG. 1. Note that the file selection screen 300 is used to select an image file to be uploaded to the book editing apparatus 101.

The file selection screen 300 displays a directory listing area 301. The directory listing area 301 displays a list of directories existing on the OS, and is used to select a directory storing image files to be uploaded. A file display area 302 is an area for displaying image files stored in the directory selected in the directory listing area 301. The file display area 302 is used to select an image file to be uploaded. It is possible to select a plurality of image files in the file display area 302, and in the example illustrated in FIG. 3, the image files of images A to J (layout objects) have been selected.

A file name designation area 303 is an area for designating file names of image files to be uploaded. The CPU 206 sets file names selected in the file display area 302, in the file name designation area 303. An upload execution button 304 is operated to upload selected image files. When the upload execution button 304 is pressed, the CPU 206 starts an uploading process, described hereinafter. A cancel button 305 is used to cancel operations for selecting image files. When the cancel button 305 is operated, the CPU 206 cancels settings made by the operations on the file selection screen 300, and closes the screen.

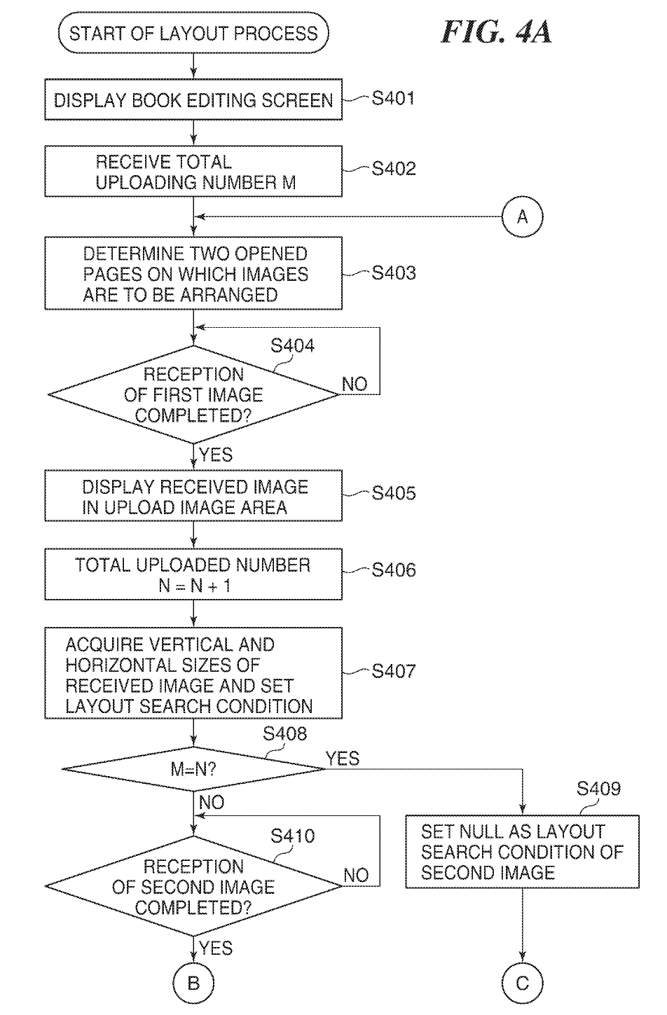

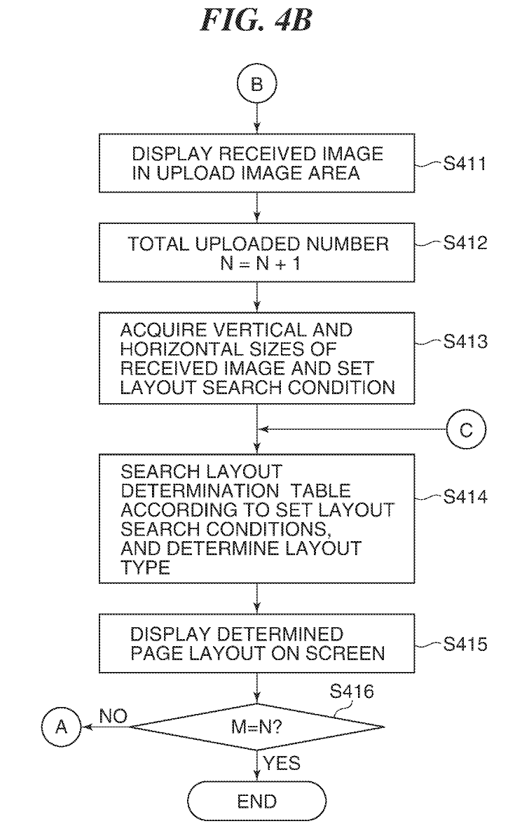

FIGS. 4A and 4B are flowcharts of a layout process performed by the book editing apparatus 101 appearing in FIG. 1. The illustrated layout process is performed under the control of the CPU 206 provided in the book editing apparatus 101.

When the uploading process is started, the CPU 206 displays a book editing screen 500 on the LCD 201 (step S401).

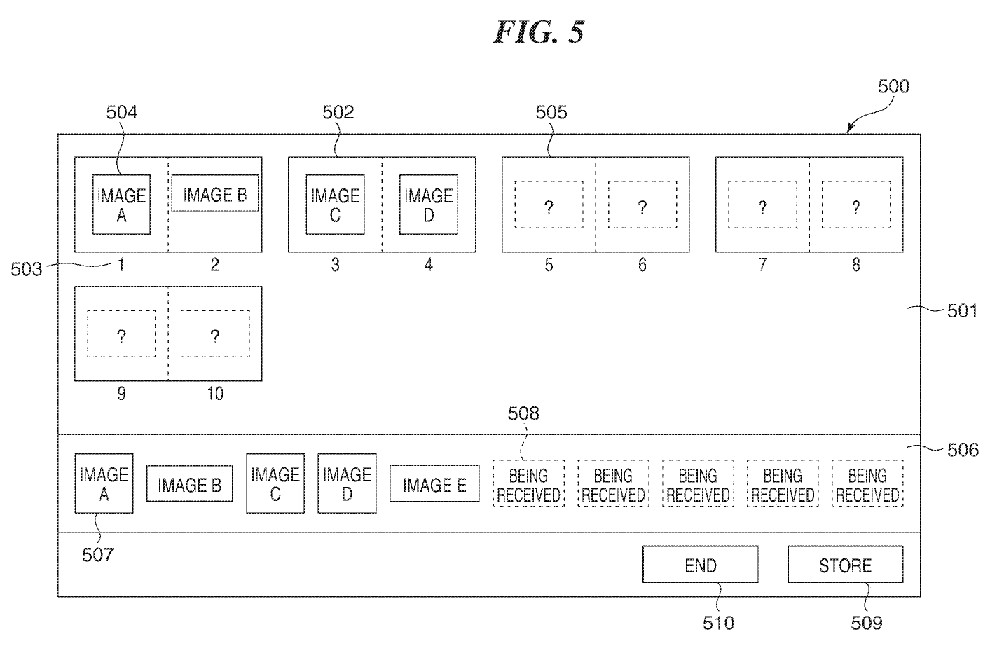

FIG. 5 is a diagram showing an example of the book editing screen 500 displayed on the book editing apparatus 101.

The book editing screen 500 is used to create a photobook, and includes a layout area 501. The layout area 501 is an area for displaying page layouts of the photobook. As shown in FIG. 5, a spread page layout 502 (in an unfolded state of a book) as a component of the photobook is displayed in the layout area 501. There are provided a plurality of page layouts 502, and different page layouts 502 are used according to whether images arranged on respective two pages are portrait images, landscape images, or a combination of a portrait image and a landscape image.

Page numbers 503 represent numbers assigned to pages of the plurality of page layouts displayed in the layout area 501. In the illustrated example, the page numbers 503 of up to “10” are assigned.

When images are uploaded from the user terminal 102 to the book editing apparatus 101, the CPU 206 arranges the uploaded images in the order of upload, on the respective pages having page numbers 503 which are in an increasing order. In a case where the page layouts of the photobook have not been determined, the CPU 206 does not arrange the uploaded images on the pages, but instead displays unarranged page layouts 505 which indicate that the uploaded images have not been arranged on the pages.

Immediately after display of the book editing screen 500, the page layouts have not been determined yet since no images have been uploaded. Therefore, as described hereinafter, the CPU 206 temporarily displays the unarranged page layouts 505 indicating that a number M of images to be uploaded have not been arranged. Note that a user operation for editing two opened pages with the unarranged page layouts 505 displayed thereon is not accepted at all. In other words, user editing of two opened pages is allowed only when the unarranged page layouts 505 are not displayed therefor but thumbnail images corresponding to the uploaded images arranged thereon are displayed therefor.

On the above-described file selection screen 300 shown in FIG. 3, since the ten images A to J have been selected, the book editing apparatus 101 receives a notification of “number of images: 10” from the user terminal 102. Then, the CPU 206 of the book editing apparatus 101 performs initial display of unarranged page layouts 505 for the ten pages in the layout area 501.

Note that FIG. 5 shows the example of the book editing screen 500 displayed during uploading process of images. In FIG. 5, pages with page numbers 1 to 4 are in a state in which page layouts thereof are determined, and hence thumbnail images 504 of uploaded images are displayed, whereas pages with page numbers 5 to 10 are in a state in which the unarranged page layouts 505 are displayed therefor since uploading of necessary images has not been completed yet and the page layouts thereof have not been determined.

In an upload image area 506, there are displayed thumbnail images 507 of uploaded images, and icons 508 corresponding to images uploading of which has not been completed yet. In the upload image area 506, as long as uploading of each image is not completed, the icon 508 is displayed which indicates that uploading of the image is not completed, whereas once uploading of the image is completed, the thumbnail image 507 of the uploaded image is displayed.

In the illustrated example, since the CPU 206 has received from the user terminal 102 the notification that the number of images to be uploaded is ten, first, the CPU 206 displays ten icons 508 in the upload image area 506 to indicate that uploading of the ten images has not been completed yet. After that, whenever each image is uploaded, the CPU 206 displays a thumbnail image 507 of the uploaded image in place of the icon 508 displayed up to that time. The illustrated example in FIG. 5 shows a state in which uploading of the five images A to E of the ten images is completed.

A storage button 509 is used to store details of editing the photobook. Further, an end button 510 is for terminating the editing of the photobook.

The example illustrated in FIG. 5 shows a state in which the page layouts of first to fourth pages are determined, and images to be arranged on fifth and sixth two opened pages are currently being uploaded. In the upload image area 506, there is the image E which has already been uploaded but has no page layout determined therefor yet, and a next image (image F) is being uploaded.

In this case, the page layouts of the pages with the page numbers 1 to 4 have been determined and the images have been arranged, so that it is possible to perform editing of the images, such as trimming and magnification/reduction of the images, by user operation. Further, it is also possible to perform editing of the pages, such as a change in the page layouts, and input of comments, by user operation.

Referring again to FIGS. 4A and 4B, the CPU 206 acquires the number M of the images to be uploaded from the user terminal 102 (the total uploading number M) (step S402). Then, the CPU 206 determines two opened pages on which images are to be arranged, on the book editing screen 500 (step S403). Here, in a first case, the CPU 206 determines the first and second two opened pages as the two opened pages on which images are to be arranged. Further, whenever the process returns from a step S416, described hereinafter, to the step S403, the CPU 206 updates the two opened pages on which images are to be arranged, while sequentially increasing the page numbers thereof to third and fourth pages, fifth and sixth pages, and so forth.

Then, the CPU 206 determines whether or not reception of the first one of the two images as a unit of layout operation is completed (step S404). If the reception of the first image is not completed (NO to the step S404), the CPU 206 waits. On the other hand, if the reception of the first image is completed (YES to the step S404), the CPU 206 determines that the first image has been uploaded, and displays a thumbnail image thereof in the upload image area 506 (step S405).

Next, the CPU 206 increments the total uploaded number N indicative of the number of images of which reception has been completed, by one (step S406). The initial value of the total uploaded number N is 0. Then, the CPU 206 acquires the vertical and horizontal sizes of the received image from attribute information thereof, and sets a layout search condition of the first image according to the vertical and horizontal sizes (step S407). In the illustrated example, if a comparison made by the CPU 206 between a vertical size and a horizontal size of the image indicates that the vertical size is larger, the CPU 206 sets the layout search condition of the first image to portrait, and if the comparison indicates that the horizontal size is larger, the CPU 206 sets the layout search condition of the first image to landscape. Note that if the vertical size and the horizontal size of the image are equal to each other, the CPU 206 sets the layout search condition of the first image to portrait.

Then, the CPU 206 compares the total uploading number M and the total uploaded number N to thereby determine whether or not M=N holds (step S408). If M=N holds (YES to the step S408), the CPU 206 sets “null” (ineffective) as a layout search condition of the second image (step S409).

If M=N does not hold, i.e. if M>N holds (NO to the step S408), the CPU 206 determines whether or not reception of the second image in the layout unit is completed (step S410). If reception of the second image is not completed (NO to the step S410), the CPU 206 waits. On the other hand, if reception of the second image is completed (YES to the step S410), the CPU 206 displays the uploaded image (the second image in this step) in the upload image area 506 (step S411).

Then, the CPU 206 increments the total uploaded number N indicative of the number of the received images by one (step S412). Then, similar to the step S407, the CPU 206 acquires the vertical and horizontal sizes of the received image (the second image in this step) from attribute information thereof, and sets a layout search condition of the second image according to the vertical and horizontal sizes (step S413).

Next, the CPU 206 determines a layout type of the first and second images according to the layout search conditions of the first and second images (step S414). Here, a description will be given of a method of determining a layout type according to the layout search conditions.

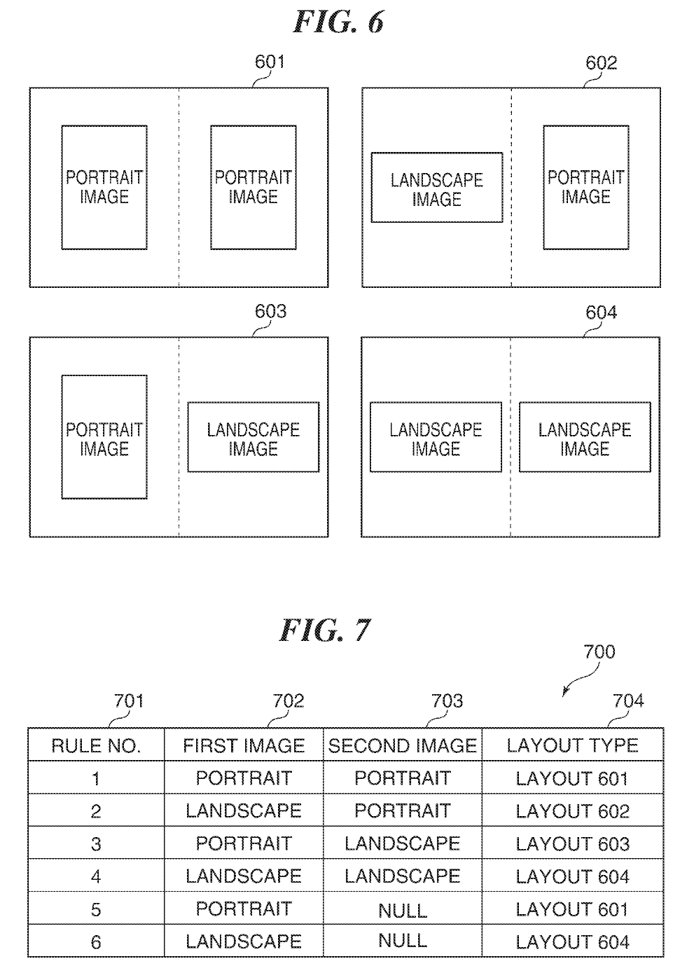

FIG. 6 is a diagram showing an example of a page layout group set in the book editing apparatus appearing in FIG. 1.

The page layout group includes layout types 601 to 604. The layout type 601 is a page layout for arranging portrait images both on left and right pages. The layout type 602 is a page layout for arranging a landscape image on a left page, and a portrait image on a right page.

The layout type 603 is a page layout for arranging a portrait image on a left page, and a landscape image on a right page. The layout type 604 is a page layout for arranging landscape images both on left and right pages. The CPU 206 of the book editing apparatus 101 displays one of the layout types 601 to 604 selected from the page layout group as the page layout 502 appearing in FIG. 5.

FIG. 7 is a diagram showing an example of a layout determination table defining rules with reference to which a layout type (also referred to as “layout pattern”) is determined by the book editing apparatus 101.

The layout determination table (hereinafter simply referred to as the “determination table”) 700 has a “rule No.” column 701, a “first image” column 702, a “second image” column 703, and a “layout type” column 704. The rule No. column 701 stores numbers for uniquely managing page layout determination rules, respectively. The first image column 702 stores the orientation (landscape or horizontal) of a first image assuming that two images form a layout unit. The second image column 703 stores the orientation (landscape, horizontal, or null) of a second image assuming that the two images form the layout unit. The layout type column 704 stores used layout types.

For example, let it be assumed that the first and second images of a layout unit are both portrait images. In this case, by consulting the determination table 700, the CPU 206 selects a rule No. 1 in which boxes of the first image column 702 and the second image column 703 associated therewith both store “portrait”, to thereby determine a layout type 601 for the two images.

Further, let it be assumed that the first image is a portrait image and the second image is a landscape image. In this case, by consulting the determination table 700, the CPU 206 selects a rule No. 3, to thereby determine a layout type 603 for the two images.

Incidentally, let it be assumed that when image data is uploaded, an odd number of images are selected on the file selection screen 300 shown in FIG. 3. In this case, in the book editing apparatus 101, the last one of the odd number of images is to be arranged on two opened pages. In this case, in the step S409 shown in FIG. 4A, the CPU 206 sets “null” as the layout search condition of the second image. Therefore, the CPU 206 selects a rule No. 5 or 6 in which a box of the second image column 703 associated therewith stores “null”, to thereby determines a layout type 601 or 604 for the image.

Referring again to FIGS. 4A and 4B, the description of the layout process is continued. In place of the unarranged page layout 505 appearing in FIG. 5, the CPU 206 arranges thumbnail images of the first and second images on the two opened pages, according to the layout type determined in the step S414, and displays the thumbnail images in the layout area 501 (step S415).

Then, the CPU 206 compares the total uploading number M and the total uploaded number N to thereby determine whether or not M=N holds (step S416). If M=N holds (YES to the step S416), the CPU 206 terminates the layout process. On the other hand, if M=N does not hold, i.e. if M>N holds (NO to the step S416), the CPU 206 returns to the step S403, to determine the layout of images on the following two opened pages.

As described above, according to the present embodiment, the layout process is performed on each of the uploaded images constituting two opened pages. This makes it possible to determine optimum layouts of images on a two opened pages-by-two opened pages basis.

Further, in the present embodiment, even when an image for the first page of each two opened pages has been uploaded, the uploaded image cannot be edited until completion of uploading of an image remaining to be uploaded for the second page. Therefore, it is possible to prevent the layout of images for two opened images from being changed when uploading of all images for the two opened pages is completed to thereby spoil editing performed before completion of uploading.

Further, in the present embodiment, if all images are uploaded for each two opened pages, editing is allowed without waiting for completion of uploading of images to be arranged on all pages forming a book. Therefore, the user can sequentially edit pages, starting with two opened pages for which page layouts have been determined, respectively.

Further, in the present embodiment, before all images are uploaded for the two opened pages of a unit of layout operation, a thumbnail image of an uploaded one of the images is not displayed on the edit screen, whereas, regardless of the unit of layout operation, a thumbnail image of each uploaded image is displayed in the upload image area whenever uploading of the image is completed. This makes it possible for the user to easily know progress of uploading of images.

Next, a description will be given of a book editing apparatus as an information processing apparatus according to a second embodiment of the present invention. Note that the hardware configuration of the book editing apparatus as the information processing apparatus according to the second embodiment is the same as the hardware configuration shown in FIG. 2.

In the above-described first embodiment, the layout process performed by the book editing apparatus 101 has been described assuming that normal images are uploaded from the user terminal 102. In the second embodiment, a description is given of a layout process performed in a case where an error image (abnormal image) is included in the uploaded images.

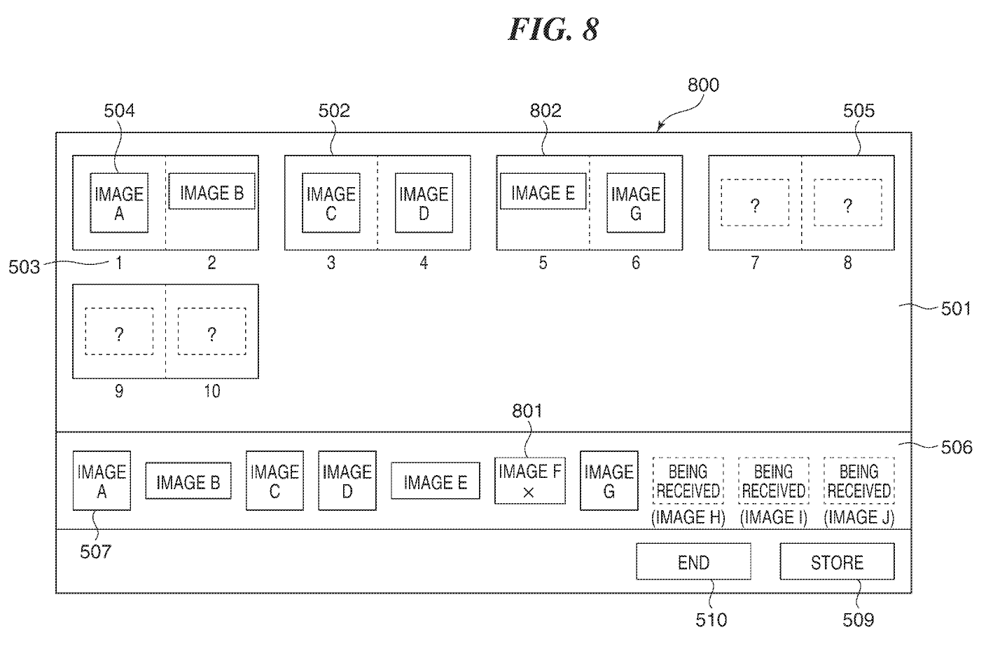

FIG. 8 is a diagram showing an example of a book editing screen displayed on the book editing apparatus of the present embodiment. Note that in FIG. 8, the same elements as appearing in FIG. 5 are denoted by the same reference numerals.

Now, let it be assumed that in FIG. 8, the image F uploaded as a sixth image is an error image. When it is determined that the uploaded image is an error image and hence cannot be used for book editing, the CPU 206 displays the book editing screen 800 shown in FIG. 8 on the LCD 201. On the book editing screen 800, an error icon 801 is displayed which is formed by adding a mark X to the error image of the image F. Then, as described hereinafter, the CPU 206 displays, next to the page layout 502 in which the images C and D are arranged, a page layout 802 in which the image E and an image G uploaded next to the image F are arranged. That is, the CPU 206 does not arrange the image F which is an error image in the page layout.

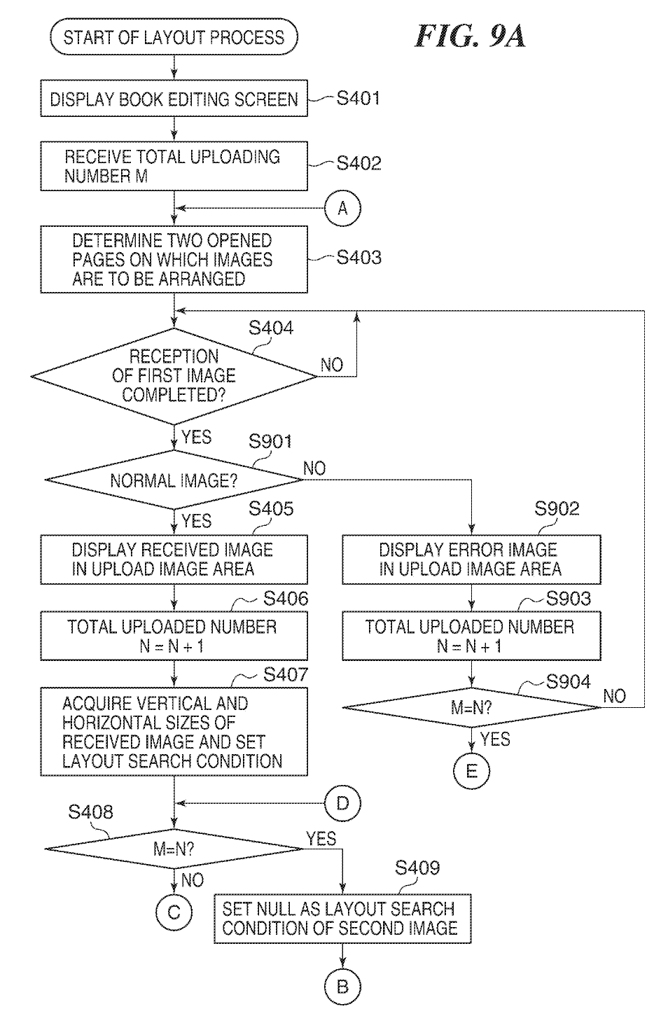

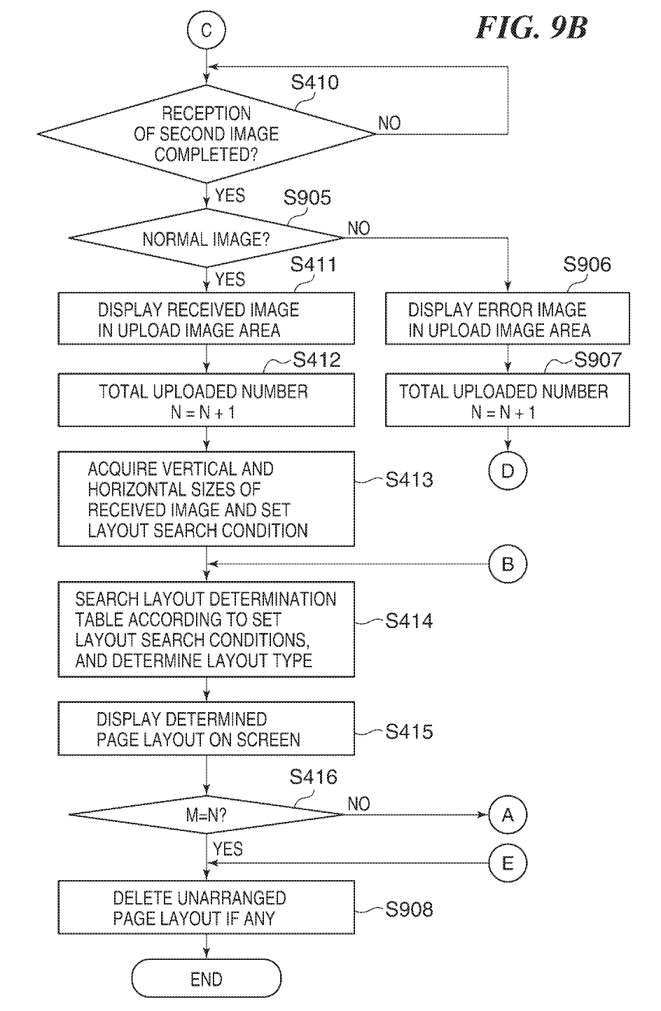

FIGS. 9A and 9B are a flowchart of the layout process performed by the book editing apparatus of the present embodiment. Note that in the flowchart shown in FIGS. 9A and 9B, the same steps as the steps in FIGS. 4A and 4B are denoted by the same step numbers, and description thereof is omitted.

In a step S404, when reception of a first image is completed (YES to the step S404), the CPU 206 determines whether or not the first image is a normal image file (step S901). Here, for example, the CPU 206 checks whether or not the first image is data in which only an extension has been changed e.g. to jpg in spite of the fact that it is not an image file. Further, the CPU 206 checks whether or not the first image is in a state in which it cannot be handled as an image since it is partly broken while being uploaded.

If the first image is normal as an image (YES to the step S901), the CPU 206 proceeds to the step S405. On the other hand, if the first image is not normal as an image (NO to the step S901), the CPU 206 displays the error icon 801 in the upload image area 506 (step S902). Then, the CPU 206 increments the total uploaded number N of the received images by one (step S903).

Then, the CPU 206 compares the total uploading number M and the total uploaded number N to thereby determine whether or not M=N holds (step S904). If M=N holds (YES to the step S904), the CPU 206 proceeds to a step S908, described hereinafter. On the other hand, if M=N does not hold, i.e. if M>N holds (NO to the step S904), the CPU 206 returns to the step S404, and receives a next first image.

If it is determined in the step S410 that reception of a second image is completed (YES to the step S410), the CPU 206 determines whether or not the second image is a normal image file (step S905). If the image file is normal (YES to the step S905), the CPU 206 proceeds to the step S411. On the other hand, if the image file is not normal (NO to the step S905), the CPU 206 displays the error icon 801 in the upload image area 506 (step S906). Then, the CPU 206 increments the total uploaded number N of the received images by one (step S907). After that, the CPU 206 returns to the step S408, to determine whether or not M=N holds.

If it is determined in the step S416 that M=N holds (YES to the step S416), the CPU 206 deletes an unarranged page layout 505, if any remains in the layout area 501, (step S908). Then, the CPU 206 terminates the layout process.

For example, referring to FIG. 8, when any of images H to J, which are being uploaded, becomes an error image in addition to the image F, a total of two images become error images. As a consequence, there are no images arranged on two opened pages of page numbers 9 and 10. Therefore, after completion of uploading of images, when there remains any unarranged page layout 505 which has no images arranged thereon, the CPU 206 deletes the unarranged page layouts 505.

As described above, in the second embodiment, when any of uploaded images for two opened pages of a unit of layout operation is not normal i.e. an error image, the error image is not used, but by using normally uploaded images, layout of images for the two opened pages is performed. This makes it possible to determine layouts using properly uploaded images, in units of two opened pages.

Although in the above-described first and second embodiments, the number of images forming two opened pages is set to two for convenience of explanation, this is not limitative. For example, page layout for arranging a plurality of images per one page may be performed. Further, although in the above-described embodiments, the description has been given of the layout process using Web services, the book editing apparatus may be an information processing apparatus equipped with a dedicated device, a dedicated application, or the like.

Further, although in the above-described first and second embodiments, the description has been given of the case where the book editing screen 500 is displayed on the book editing apparatus 101, this is not limitative. For example, the book editing apparatus 101 may be configured to generate display data for displaying the book editing screen 500, and transmit the display data to the user terminal 102 to cause the book editing screen 500 to be displayed on the user terminal 102. Further, user operation may be notified from the user terminal 102 to the book editing apparatus 101 to cause the book editing apparatus 101 to transmit display data updated according to the user operation to the user terminal 102.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, a control method based on the functions of the above-described embodiments may be caused to be executed by the information processing apparatus.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-166849 filed Aug. 29, 2016 which is hereby incorporated by reference herein in its entirety.

What is claimed is:

1. An information processing apparatus that performs a layout process for laying out layout objects to be laid out on pages, comprising:
a reception unit configured to receive each layout object;
a display unit configured to additionally display the layout object in a first area, whenever the layout object is received;
a decision unit configured to decide, based on attribute information of a plurality of the layout objects to be laid out on pages, a layout pattern for laying out the plurality of the layout objects on the pages; and
a control unit configured to perform control such that whenever each layout pattern for associated ones of the pages is decided, associated ones of the layout objects are laid out on the associated pages, according to the decided layout pattern, and are additionally displayed in a second area different from the first area by the display unit.

2. The information processing apparatus according to claim 1, further comprising an acquisition unit configured to acquire the number of layout objects having already been received, before layout objects are laid out, and
wherein the control unit controls whether or not to lay out the layout objects, based on the number.

3. The information processing apparatus according to claim 1, wherein the decision unit decides the layout pattern according to a size of each of the associated objects to be laid out on the associated pages.

4. The information processing apparatus according to claim 1, wherein the layout objects are laid out on the pages according to an order of reception of the layout objects by the reception unit.

5. The information processing apparatus according to claim 1, wherein the control unit allows editing, by user operation, on pages on which the associated layout objects have been laid out and which have been displayed in the second area.

6. The information processing apparatus according to claim 1, further comprising a determination unit configured to determine whether or not the received layout object is a normal layout object, and
wherein in a case where it is determined by the determination unit that the received layout object is not a normal layout object, the control unit causes a display to be made to the effect that the layout object is an error, on the display unit.

7. The information processing apparatus according to claim 1, wherein the layout object is an image.

8. The information processing apparatus according to claim 1, wherein the reception unit receives the layout objects from another information processing apparatus via a network.

9. A method of performing a layout process for laying out layout objects on pages, comprising:
receiving each layout object;
additionally displaying the layout object in a first area, whenever the layout object is received;
deciding, based on attribute information of a plurality of the layout objects to be laid out on pages, a layout pattern for laying out the plurality of the layout objects on the pages; and
laying out, whenever each layout pattern for associated ones of the pages is decided, associated ones of the layout objects on the associated pages, according to the decided layout pattern, and additionally displaying the associated ones of the layout objects in a second area different from the first area.

10. A non-transitory computer-readable storage medium storing a computer-executable program for executing a method of performing a layout process for laying out layout objects on pages,
wherein the method comprises:
receiving each layout object;
additionally displaying the layout object in a first area, whenever the layout object is received;
deciding, based on attribute information of a plurality of the layout objects to be laid out on pages, a layout pattern for laying out the plurality of the layout objects on the pages; and
laying out, whenever each layout pattern for associated ones of the pages is decided, associated ones of the layout objects on the associated pages, according to the decided layout pattern, and additionally displaying the associated ones of the layout objects in a second area different from the first area.
